(19) United States
(12) Patent Application Publication
(10) Pub. No.: US 2007/0182780 A1
(43) Pub. Date: Aug. 9, 2007

(54) Guide for guiding a moveable carriage of a printer in a print direction, and printer

(76) Inventor: Jonathan H.J.J. Nikkel, Vancouver (CA)

Correspondence Address: BIRCH STEWART KOLASCH & BIRCH, PO BOX 747, FALLS CHURCH, VA, 22040-0747, US

(21) Appl. No.: 11/346,188

(22) Filed: Feb. 3, 2006

(51) Int. Cl. B41J 23/00

(52) U.S. Cl. 347/37

(57) ABSTRACT

A guide for guiding a moveable carriage of a printer in a print direction includes a pair of spaced apart guiding rods. At least one support frame is provided with at least two elongated recesses, each of the recesses is adapted to accommodate at least a part of a guiding rod. A magnet magnetically attracts each guiding rod into a corresponding recess to establish physical contact between each guiding rod and the support frame.

### BACKGROUND OF THE INVENTION

1. Field of the Invention

The present invention relates to a guide for guiding a moveable carriage of a printer in a print direction. The present invention further relates to a printer, including a carriage and a guide for guiding the carriage in a print direction.

2. Description of Background Art

Guides for guiding a moveable carriage of a printer are known in the background art. These guides allow the carriage to be moved bidirectionally along the guide in a print direction. Commonly, the known guide comprises a set of two substantially parallel smooth, spaced apart guide rods made of steel on which the carriage is mounted. The rods, in particular the extremities of the rods are bolted onto a support structure in a predetermined manner. Bolting the rods onto the guide is commonly considered to be advantageous, since this kind of attachment allows support of relatively heavy carriages. The design of both the carriage and the guide is extremely critical to allow low friction movement of the carriage along the guide. Initially, the rods of the guide are aligned in a predetermined manner to optimize guiding of the carriage along the guide, after which alignment the rods are bolted to the support structure. However, due to thermal expansion of the bolted rods during use, the (initial) linear design of the rods cannot be secured. During heat-up of the guide, the rods will be forced into a non-linear, commonly sinuate, design. Movement of the carriage along the guide is hindered as a result of the non-linear design.

### SUMMARY OF THE INVENTION

It is an object of an embodiment of the present invention to provide an improved guide for guiding a carriage in a relatively smooth manner. This object can be realized by providing a guide for guiding a moveable carriage of a printer in a print direction, the guide comprising: a pair of spaced apart guiding rods; at least one support frame provided with at least two elongated recesses, each of said recesses being adapted for accommodating at least a part of a guiding rod; and a magnet for magnetically attracting each guiding rod into a corresponding recess thereby establishing physical contact between each guiding rod and the support frame.

The contact between the guiding rod and the support frame may be such that each guiding rod contacts each part of the support frame defining the corresponding recess. In the guide according to an embodiment of the present invention both recesses are positioned and shaped in a predefined manner to optimize accommodation of the rods, or at least a part thereof, such that movement of the carriage along the rods can take place relatively unhindered, independent of the thermal state of both the guide and the carriage mounted thereon. The recesses preferably substantially extend in the print direction. Magnetically attracting the rods allows substantially unhindered displacement, and in particular expansion, of these rods during heat-up of the guide, as a result of which the linearity of both rods can be secured in an optimum manner.

Moreover, a direct physical contact between each rod and each corresponding recess is established by means of the magnet. Therefore, the recesses are preferably adapted to establish at least one line contact between each guiding rod and each part of the support frame defining the corresponding recess. Realizing one or more line contacts between the rods and the support frame commonly improves stable support of the rods, thereby further securing linear precision of the guiding rods, and thereby also improving the load capacity of the guiding rods. Preferably, the at least one line contact substantially extends along the length of the corresponding recess to optimize these latter effects. The number of line contacts between each guiding rod and each recess is dependent on the design of both the guiding rod and the recess. Commonly, the guiding rod is shaped substantially circularly in cross-section. In case of a tight-fit between the guiding rod and the recess, wherein the guiding rod could have a similar, though inverted shape in cross-section, the number of line contacts is considered to be infinite. However, preferably, each recess is defined by at least two surfaces of the support frame, said surfaces mutually enclosing an angle. More preferably, the surfaces of the support frame define in cross-section a substantially V-shaped recess or a truncated V-shaped recess. In this manner, commonly two line contacts will be present between each guiding rod and the corresponding recess.

In order to optimize the physical (line) contact between each guiding rod and the corresponding recess, each recess is preferably defined by a substantially smooth part of the support frame. Moreover, a relatively smooth (plain) surface of the support frame defining each recess will facilitate expansion of the rods due to thermal influences, which will be in favor of the linear precision of the guide according to the present invention.

Although the recesses could be provided at different parts of the support frame, preferably, the recesses are provided at opposite faces of the support frame. This facilitates manufacturing of the support frame and the reference surfaces created therein. According to an embodiment of the present invention, two substantially parallel V-grooves can, e.g. be milled in opposing surfaces of an extruded aluminium support frame. An advantage of this design is that only a single set-up is required to perform all necessary machining actions. For a person skilled in the art it is also conceivable that the recesses are formed during extrusion of the support frame.

The magnet for attracting the guiding rods into the corresponding recesses could be of various nature. The magnet may comprise one or more electromagnets. However, preferably the magnet comprises one or more permanent magnets. The positioning of the magnets may also be of various nature. The magnets may be part of the support frame, wherein the magnets may be applied as a magnetic coating, said coating defining the recesses. However, preferably, the magnets are positioned such that no contact is established between the magnets and the guiding rods when attracted in their corresponding recesses. From a practical point of view, the magnets may be positioned at a distance from the recesses. The magnets may be positioned at least partially inside the support frame adjacent the recesses without contacting the guiding rods when attracted into the recesses. For instance, the support frame may comprise at least one aperture for accommodating the magnets.

Commonly, the support frame and the guiding rods are composed of substantially different materials. The guiding rods are commonly made of steel, while the support frame is often formed by an extrusion profile made of aluminium. Typically, in this embodiment, bolting the guiding rods to the support frame, and thereby literally fixating both components to each other, would be undesirable due to a considerable difference in heat expansion between both components. By applying the magnets, a freedom of bidirectional movement, in particular expansion, of the guiding rods can be secured. Therefore, expansion of the rods due to thermal influences will be permanently and substantially unhindered.

The present invention also relates to a support frame for use in a guide according to the present invention. The support frame is preferably made of an extruded profile, which may be made of aluminium. The support frame can be marketed separately.

The present invention further relates to a printer comprising: a printer carriage; and a guide according to the present invention for guiding said carriage in a print direction. The printer carriage and the support frame could be made of substantially the same material.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a perspective view of an inkjet printer;

FIG. 2 is a perspective view of a guide according to the invention as used in the printer according to FIG. 1; and

FIG. 3 is a cross-section of an assembly of a guide and a carriage as used in the printer according to FIG. 1.

### DETAILED DESCRIPTION OF THE PREFERRED EMBODIMENTS

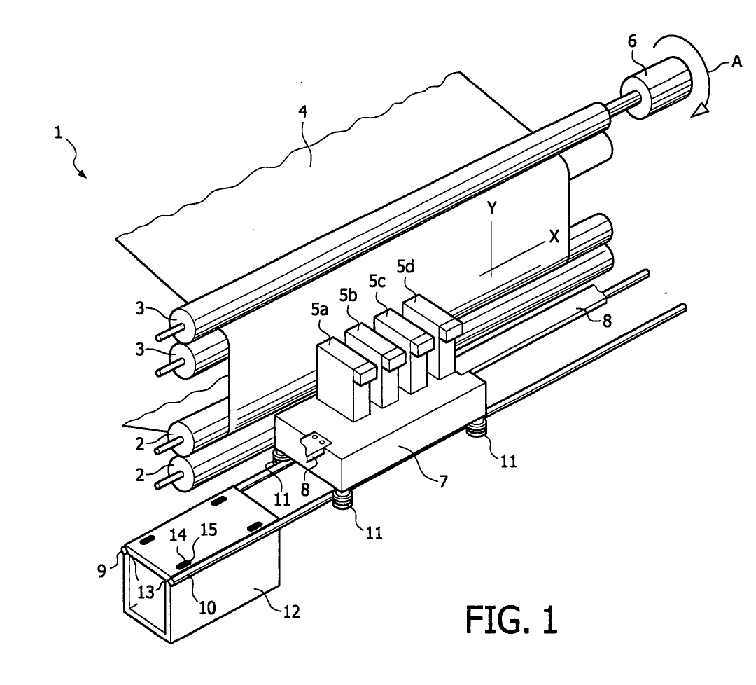

The present invention will now be described with reference to the accompanying drawings, wherein the same or similar elements will be identified with the same reference numerals. FIG. 1 is a perspective view of an inkjet printer 1. The printer 1 includes two pairs of rollers 2 and 3 for supporting a receiving material 4, for example a sheet of paper, and feeding it along four print heads 5a, 5b, 5c and 5d (each print head for one of the colors black, cyan, magenta and yellow). Roller pair 3 is drivable by means of motor 6. In this case the top one of the two rollers 3 is actively driven in a direction indicated by arrow A. As a result, the receiving material 4 can be displaced in the sub-scanning direction Y so that the receiving material 4 can be moved with respect to the print heads 5a, 5b, 5c, 5d. A scanning carriage 7 carries the four print heads 5a, 5b, 5c and 5d and can be reciprocated in the main scanning direction X, parallel to the roller pairs 2 and 3. For this purpose, a conveyor belt 8 is fixed to the scanning carriage 7 so that the latter can be moved over the guide system formed by steel guiding rods 9 and 10. The print heads 5a, 5b, 5c, 5d can completely scan the receiving material 4 by the combination of the movement of the scanning carriage in the sub-scanning direction Y and the main scanning direction X. The scanning carriage 7 is in sliding connection with the guide system via supporting wheels 11. Each wheel 11 thereby forms a hardened steel roller bearing, which is adapted to cooperate with a respective guiding rod 9, 10 to stabilise the scanning carriage 7, in particular during movement. Both guiding rods 9, 10 are preferably similar, though could be different in dimensioning and eventually in shape. The guiding rods 9, 10 are supported by a support frame 12 (of which merely a part is shown). The support frame 12 is provided at opposite sides with two recesses 13 for at least partially receiving the respective rods 9, 10. The support frame 12 is provided with multiple permanent magnets 14, such as rare earth neodymium 30 magnets, to magnetically attract the rods 9, 10 into the respective recesses 13. The magnets 14 are accommodated in slots 15 formed in the support frame 12. The slots 15 are positioned at distance from the recesses 13.

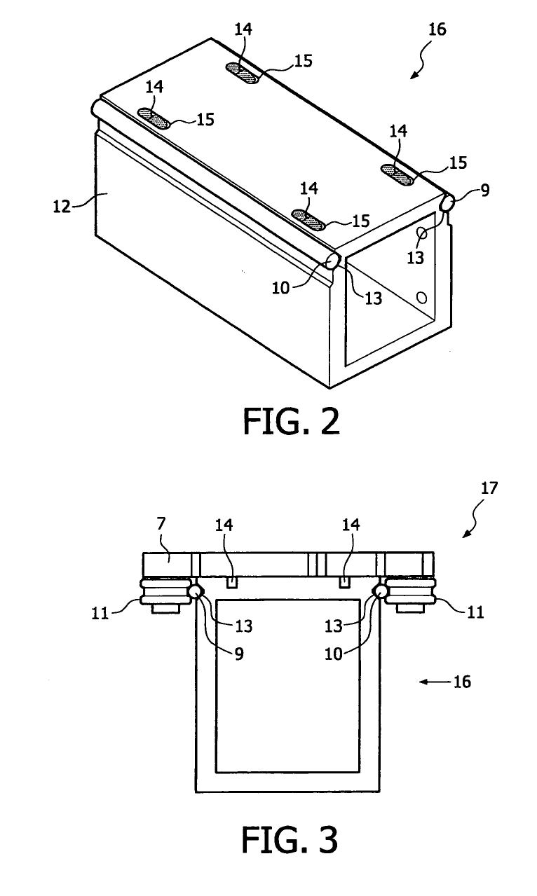

FIG. 2 is a perspective view of a guide 16 according to the present invention as used in the printer 1 according to FIG. 1. The guide 16 includes the support frame 12, the magnets 14 accommodated in the slots 15 of the support frame 12, and the rods 9, 10 attracted by means of the magnets 14 into the recesses 13 of the support frame 12. By magnetically attracting the rods 9, 10 into the recesses 13, the rods 9, 10 are substantially fixed two-dimensionally, although a freedom of displacement in the radial direction is preserved. As a result, thermal expansion of the rods 9, 10 is still possible. In this manner, the linearity of the rods 9, 10, even during heating-up, can be secured. The recesses 13 are defined by two surfaces of the support frame 12 mutually enclosing an angle. In cross-section, each recess 13 is formed substantially V-shaped. As a result, two line contacts are present between each rod 9, 10 and each corresponding recess 13. The line contacts extend along substantially the whole length of the recesses 13.

FIG. 3 is a cross-section of an assembly 17 of the guide 16 and the carriage 7 as used in the printer 1 according to FIG. 1. Both rods 9, 10 are attracted in the direction of the recesses 13 of the support frame 12 by means of the magnets 14 accommodated within the support frame 12. The wheels 11 of the carriage 7 are formed by roller bearings, which are preferably formed of hardened steel.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A guide for guiding a moveable carriage of a printer in a print direction, the guide comprising:
a pair of spaced apart guiding rods;
at least one support frame provided with at least two elongated recesses, each of said recesses being adapted for accommodating at least a part of a guiding rod; and]
a magnet, said magnet magnetically attracting each guiding rod into a corresponding recess thereby establishing physical contact between each guiding rod and the support frame.

2. The guide according to claim 1, wherein the recesses extend substantially in the print direction.

3. The guide according to claim 1, wherein the recesses are adapted to establish at least one line contact between each guiding rod and the support frame.

4. The guide according to claim 1, wherein each recess is defined by at least two surfaces of the support frame, said surfaces mutually enclosing an angle.

5. The guide according to claim 4, wherein the surfaces of the support frame define a substantially V-shaped recess in cross-section.

6. The guide according to claim 1, wherein the support frame comprises at least one aperture for accommodating the magnet.

7. The guide according to claim 1, wherein the magnet comprises multiple magnets for attracting the guiding rods into the respective recesses.

8. The guide according to claim 1, wherein the magnet is positioned at a distance from both recesses.

9. The guide according to claim 1, wherein the support frame and the guiding rods are composed of substantially different materials.

10. The guide according to claim 1, wherein the magnet is a permanent magnet or an electromagnet.

11. A printer comprising:
a printer carriage; and
a guide for guiding said printer carriage in a print direction, said guide comprising:
a pair of spaced apart guiding rods;
at least one support frame provided with at least two elongated recesses, each of said recesses being adapted for accommodating at least a part of a guiding rod; and]
a magnet, said magnet magnetically attracting each guiding rod into a corresponding recess thereby establishing physical contact between each guiding rod and the support frame.

12. The printer according to claim 11, wherein the recesses extend substantially in the print direction.

13. The printer according to claim 11, wherein the recesses are adapted to establish at least one line contact between each guiding rod and the support frame.

14. The printer according to claim 11, wherein each recess is defined by at least two surfaces of the support frame, said surfaces mutually enclosing an angle.

15. The printer according to claim 14, wherein the surfaces of the support frame define a substantially V-shaped recess in cross-section.

16. The printer according to claim 11, wherein the support frame comprises at least one aperture for accommodating the magnet.

17. The printer according to claim 11, wherein the magnet comprises multiple magnets for attracting the guiding rods into the respective recesses.

18. The printer according to claim 11, wherein the magnet is positioned at a distance from both recesses.

19. The printer according to claim 11, wherein the support frame and the guiding rods are composed of substantially different materials.

20. The printer according to claim 11, wherein the magnet is a permanent magnet or an electromagnet.
